(19) United States
(12) Patent Application Publication
(10) Pub. No.: US 2008/0296232 A1
(43) Pub. Date: Dec. 4, 2008

(54) Wastewater clarifier and process

(76) Inventor: Paul Wegner, San Carlos, CA (US)

Correspondence Address: BENASUTTI, P.A., 17294 BERMUDA VILLAGE DRIVE, BOCA RATON, FL, 33487, US

(21) Appl. No.: 12/152,689

(22) Filed: May 16, 2008

Related U.S. Application Data
(60) Provisional application No. 60/932,350, filed on May 31, 2007.

(51) Int. Cl. C02F 1/52; C02F 11/12; C02F 1/66

(52) U.S. Cl. 210/725; 210/96.1; 210/93

(57) ABSTRACT

An apparatus and method are disclosed to purify wastewater of many different compositions by controlling the pH and the flocking of the particulate matter in the water and by gently dewatering the flock produced in the process.

### CROSS-REFERENCE TO RELATED PATENT APPLICATION

This application is a continuation-in-part of my prior U.S. patent application No. 60/932,350 filed May 31 2007 the disclosure of which is incorporated herein by reference as if fully set forth.

### TECHNICAL FIELD

This invention relates to waste water clarification means and methods.

### BACKGROUND ART

Wastewater is derived from many industrial and public processes such as drilling wells, for drinking water for cities and city sewage systems. These activities create large amounts of waste water with large amounts of suspended solids. Often they produce 1,000,000 gallons of water a day.

A board spectrum of wastewater is clarified, that is, treated to remove suspended solids with the use of cationic polymers (which are more expense and toxic than anionic polymers) and high levels of water treatment polymers. The clarification of industrial and public wastewater is difficult, since its composition and concentration of suspended solids vary so widely.

Furthermore, in the prior art suspended solids in wastewater cannot be removed and dewatered economically above 100 gpm in many cases.

A clarification system that can process a wide range of waste streams and is based on low environmental impact and inexpensive materials is desirable. Cationic polymers are used for the treatment of organic waste in spite of higher cost and increased toxicity to fish. The use of anionic polymer flocking materials is preferred, since they are less expensive and less toxic than cationic polymers. Minimizing the use of polymers and mechanical dewatering devices is desirable.

Fine colloidal solids such as alumina, silica, and aluminum silicate are difficult to remove with polymeric flocking materials. The presence of alkaline water conditioners, such as sodium carbonate or sodium phosphate, further inhibits the activity of flocking materials.

A simple method of determining the proper amount and type of materials to add is desirable.

Treated waste water frequently requires elevated amounts of treatment chemicals or repeated treatment to overcome the damage to well formed flock caused by pumps and various high shear dewatering devices, such as filter presses, screw presses, or centrifuges.

### DISCLOSURE OF THE INVENTION

### SUMMARY OF THE INVENTION

My invention circumvents these problems by dewatering the fragile flock in the wastewater through gentler means which consolidates the solids for disposal or further dewatering by conventional means.

The wastewater is treated by adding a coagulant, adjusting the pH to about 7 with a coagulant or a calcium salt, adjusting the pH to about 8 with calcium hydroxide, and adding an anionic polymer to produce clarified water.

Solids are dewatered under gentle conditions, thereby, reducing the amount of water treatment chemicals required.

### BRIEF DESCRIPTION OF THE DRAWINGS

FIG. 1 is a flow diagram of the steps of the preferred embodiment of my clarifier process;

FIG. 2 is a side section of a clarifier tank used in my process;

FIG. 3 is a schematic plan view of the tank of FIG. 1 showing the positioning of drain walls and pipes;

FIG. 4 is a schematic drawing of a portion of an apparatus in accordance with my invention; and

FIG. 5 is a flow diagram of the steps performed by the automated apparatus in accordance with the preferred embodiment of my clarifier process.

### DESCRIPTION OF THE PREFERRED EMBODIMENTS

Since the makeup of the waste water varies greatly depending on the process from which it was derived, it is difficult to provide a universal system to clarify the waste water. By clarify, I mean separate out the solids and provide a clear, useable discharge water.

The factors that influence the ability to clarify water are:

Particle size: extremely fine particle size solids are difficult to flock and usually require large amounts of polymer for successful flocking. Flocking means clumping together solids into large particles that will readily settle out.

Naturally occurring inorganic soaps: sodium carbonate, sodium phosphate, ammonium phosphate, and the like will inhibit the formation of flock.

Low-density solids: fats, proteins, magnesium carbonate, aluminum oxide, and aluminum silicate inhibit the settling of solids due to their relatively low density.

Insufficient solids: not enough solids to generate flock.

Solids which blind: bentonite and gel like solids rapidly blind filters.

I have developed a method that can handle the majority of wastewater streams.

Wastewater is treated in the following manner for the rapid clarification of the waste water:

1) The first step is always to guarantee that there is a sufficient amount of high-density solids for flocking. In the preferred embodiment, to provide this, add sufficient iron to the wastewater stream. This is adjusted upward in the case of low-density solids such as sewage.

I add coagulant (selected from the group consisting of: aluminum sulfate, ferric sulfate, aluminum chloride, ferric chloride, aluminum nitrate, ferric nitrate) to wastewater. The coagulant addresses the issue of wastewater, which contains very low levels of suspended solids and/or the presence of organic matter. Anionic polymers require some suspended solids to produce flock effectively. In the case of wastewater with high organic waste, a higher level of coagulant is required, since these coagulants form insoluble complexes with the organic waste.

Step 1 above is not required if the wastewater contains adequate amounts (that is, a minimum of 10 parts per million) of the elements of silicon, iron, or aluminum in the form of compounds such as silica, aluminosilicates, alumina, iron silicate, iron hydroxide, sodium aluminate, and the like.

Wastewater that is high in organic matter usually requires higher amounts of the coagulant specified in step 1.

Step 1 improves clarification of wastewater which has organic matter or low levels of suspended solids.

2) If the resulting mixture is alkaline, adjust the pH with an acidic calcium salt (preferably selected from the group consisting of: calcium chloride, calcium sulfate, or calcium nitrate) or a coagulant (selected from the group consisting of: aluminum sulfate, ferric sulfate, aluminum chloride, ferric chloride, aluminum nitrate, ferric nitrate) to a pH of about 7.

These salts convert alkaline sodium salts (sodium carbonate, sodium hydroxide, sodium phosphate) which interfere with the anionic polymer flocculent, into non-interfering neutral sodium salts such as sodium sulfate or sodium chloride, while increasing the level of the corresponding sparingly water soluble salts of calcium carbonate, calcium hydroxide, and calcium phosphate. Calcium nitrate is preferred in case of organic waste for odor control, preventing the conversion of ferric to ferrous, and minimizing water soluble salt levels (since the nitrates are consumed by the bacteria and converted to nitrogen gas plus calcium carbonate).

A source of calcium salts which have low water solubility, minimizes the amount of polymer and process chemical required. For example, calcium aluminate has a lower water solubility than calcium sulfate and is therefore preferred. Calcium salts are generally less soluble at a pH greater than 6. A pH of 7 to 9 is preferred to minimize pipe corrosion and meet discharge standards. Several calcium salts in this pH range exhibit low water solubility.

Virtually all inorganic soaps are neutral to alkaline in nature. Therefore, a pH meter determines if they are present. If the pH is greater than seven, then I add an acidic calcium or magnesium salt, such as calcium chloride, calcium nitrate, calcium sulfate, magnesium chloride or magnesium sulfate until a pH less than 7 is reached.

Monovalent anions such as calcium nitrate and calcium chloride are preferred.

This step converts salt such as sodium carbonate and sodium phosphate into insoluble calcium salts, such as calcium carbonate, calcium phosphate and soluble salts, such as sodium chloride, sodium nitrate or sodium sulfate which do not have soap properties.

If the waste stream is less than pH 7, this second step is skipped.

3) Adjust the pH to about 8 with calcium hydroxide. A pH of 8.5 is most preferred. Many calcium salts, reach minimum solubility at a pH of 8.5. Adjust the pH to about 8 by adding calcium or magnesium hydroxide or alkaline calcium or magnesium salts. The calcium or magnesium ions react with iron, silicates, aluminates, and organic iron salts to produce large particles by cross-linking. Normally, much more expensive and toxic cationic polymers are required for this function. A swing from acidic to alkaline occurs. The addition of calcium hydroxide until an alkaline pH (7 to 9) is reached, assures the formation of solids which contain calcium, such as calcium silicate, calcium aluminosilicate, calcium ferrate or calcium aluminate. These solids are preferred since they are sparingly soluble in water and have calcium on the surface. Acidic pH inhibits the formation of solids which contain calcium on the surface. High levels of water soluble calcium inhibit the flocking action of anionic polymer by reacting with the polymer in lieu of reacting with the calcium on the surface of the solids.

The key point to steps 2 and 3 above is that a significant pH swing from acidic to alkaline occurs. For example, a pH swing from 6 to 9 may be needed in some cases. However, this only involves adjusting the set point on two pH controllers.

Adjusting the pH to about 8 with calcium hydroxide before the addition of anionic polymer enhances the clarification process.

In all cases, the calcium reacts synergistically with the added coagulant and/or minerals present in the water sample to aid in the clarification process.

It is critical that only minimal shearing action occur after this step 3 is complete.

4) Add an anionic polymer with gentle mixing until the desired level of clarification is obtained. If clarity is not achieved, more coagulant (as in step 1) is required. Preferably high molecular weight polymer is used. Polymer concentrations of 0.05% are typical of the concentrations of polymer that you mix with the solids. This polymer reacts with calcium on the surface of the solids to produce a flock.

When you properly treat wastewater in a jar test, you get clear water on the top and solids on the bottom.

The addition of dilute high molecular weight anionic polymer at concentrations of less than 0.1% in de-ionized, distilled or product water from the process itself, is preferred. A ratio of less than 10 parts wastewater to one part polymer solution gives the best results. This approach minimizes the amount of polymer required.

Since the calcium or magnesium ions do the majority of cross-linking, the amount of anionic polymer is greatly reduced.

The execution of steps 1 through 4 generates settable solids over a broad spectrum waste stream types.

The total reaction time including settable flock formation occurs in less than two minutes. This means that very high flow rates can be handled in rather small settling tanks.

An example of an anionic polymer is a high molecular weight polymer having a 1% to 40% charge anionic polymer. A commercially availably example is Accepta 4212 very high molecular weight anionic polyacrylamide polymer which has a mole % charge of 18%. This is a granular powder made by Accepta Ltd., Duckworth House, Talbot Road, Manchester, England.

Make up a polymer stock solution having a concentration typically of 1% and ideally 0.5%. Powdered polymer is gradually added to a mixing tank, which is full of water. Mixing is continued until all the polymer is in solution.

A typical wastewater to diluted polymer solution dilution ratio is 1 part diluted polymer solution to 10 parts treated wastewater. The preferred range is between 20/1 to 2/1 to allow for efficient use of the polymer. The comparatively low ratio of treated wastewater to dilute polymer solution results in lower polymer consumption.

The addition of dilute polymer has to be done in real time, on the spot on an as needed basis (or else, there would have to be too large a build up of solution in a huge storage tank to meet dilute polymer requirements). It must be done on a moving stream.

Example: a jar test would be performed treating the 1000 mL wastewater described in steps one through three. Then a 0.05% solution would be added stepwise with gentle mixing until clarification took place. If clarification is achieved with 1 mL addition of 0.05% polymer solution, then a second jar test is performed by replacing the 1 mL 0.05% polymer with a polymer solution consisting of 0.5 mL 0.05% polymer and 100 mL of water. The same result was achieved with half the polymer amount.

The addition of the calcium hydroxide creates alkaline conditions. It is important once you start adding the polymer to prevent the shearing action. In the industry, the wastewater after having the polymer added to it, is normally run through a pump; which destroys the ability of the polymer to maintain flock.

Anionic polymers are effective at flocking suspended solids which contain calcium. For example, a colloidal alumina or silica slurry is difficult to clarify with anionic polymer, while a calcium aluminate or calcium silicate clarifies readily with anionic polymers. The presence of alkaline alkali metal salts such sodium carbonate inhibits the reaction of anionic polymers with calcium solids and must be converted to neutral, non-interfering salts such as sodium sulfate or sodium nitrate.

5) Separate the clarified water from the solids by decanting the water from a clarifier tank and then dewatering the flock in the tank through gentle means for dewatering substantially without subjecting the flock to shear. Decanting may be done by letting the water flow over a weir on the side of the tank, as more and more flock containing water is introduced into the tank.

Many types of wastewater can be clarified with limited information about the waste water.

This method can be automated in the following manner.

The wastewater is feed at a known rate into a mixing tank where an iron sulfate metering pump is set to produce a minimum dosing level regardless of pH. The pH sensor/controller adjusts the calcium chloride metering pump feed rate to maintain a pH equal to about 7. The pH sensor is located at the end of the mixing pipe in which the calcium chloride and wastewater are combined. The resulting mixture is introduced into a second mixing tank which adds and mixes lime with this mixture. A second pH sensor is located after this mixing pipe. This pH sensor/controller adjusts the calcium hydroxide metering pump to maintain a pH of about 8. This mixture enters into a third mixing pipe where a dilute anionic polymer solution is added by a metering pump. The amount of polymer added can be adjusted manually or with a turbidity meter/controller which monitors the clarity of the treated water.

Simple jar testing which follows the same steps described above is desirable to set initial dosing parameters, that is, the amount of iron, acidic calcium or magnesium salts, alkaline calcium or magnesium salts and polymer. The inputting of the initial dosing parameters in the controller allows the system to come to equilibrium in a much shorter period of time. Simple jar testing is also desirable in setting the initial coagulant level for wastewater which is high in organic matter. The coagulant level is increased until the desired level of clarification is obtained at the end of the process.

### EXAMPLES

The following examples illustrate the broad spectrum of wastewater types using this method. All the examples produced clarified the water in spite of a large variation in solids loading, pH, particle surface area, particle size, organic content, inorganic content, and inorganic composition.

1) Fumed silica is very fine high surface area silica having 0.2 micron particle size diameter and a surface area of 200 square meter/gram. This is mixed with water to form an acidic aqueous silica slurry. This is normally difficult to clarify due the high surface area and fine particle size.

Ferric chloride is added to increase iron content to 10 ppm.

Since the solution is acidic, the next step is skipped and the pH of the slurry is adjusted with lime to pH 8.5 to form a calcium silicate suspension.

This readily flocks with a small addition of 0.02% anionic polymer.

A 0.02% anionic polymer solution is added to the slurry stepwise and gently mixed until clarified.

2) Fumed alumina (very fine high surface area alumina 0.2 micron 200 square meter/gram) is mixed with water to form an acidic aqueous alumina slurry which is normally too difficult to clarify due to the high surface area and fine particle size. The pH of the slurry is adjusted with lime to pH 8.5. A 0.02% anionic polymer solution is added stepwise and gently mixed until clarified.

3) An alkaline fumed alumina slurry is treated in the following manner. Calcium sulfate slurry is added until a pH of 7 is obtained. The pH of the slurry is adjusted with lime to pH 8. A 0.02% anionic polymer is added stepwise and gently mixed until clarified.

3.1) Fine alumino silicate clay slurry (100 ppm alumino silicate). This waste has a very low suspended solids content. Therefore, there are not enough dense solids to flock with. Ferric chloride is added to increase iron content to 10 ppm. Since the solution is acidic step 2 is skipped and lime is added to reach a pH of 8.5. This readily flocks with a small addition of 0.1% anionic polymer.

4) A neutral(pH=7) kaolin clay (an alumino silicate clay) slurry is treated by adjusting the pH to 9 with lime. A 0.02% anionic polymer solution is added stepwise and gently mixed until clarified.

5) A water sample with less than 50 ppm suspended solids is treated by adding ferric sulfate to increase the iron level by 10 ppm. The resulting water had a pH less than 7. Lime was added to obtain a pH of 8. A 0.02% anionic polymer solution was added stepwise and gently mixed until clarified.

6) A water sample containing fecal matter of alkaline pH was treated by adding ferric chloride to increase the iron level by 100 ppm. The pH of this mixture was 7. Lime was added until a pH of 8 was obtained. A 0.02% anionic polymer solution is added stepwise and gently mixed until clarified.

(6.1) Sewage water: this waste has a very high organic content. Therefore, a high level of ferric chloride is added (100 ppm iron). The iron adds sufficient density to solids to facilitate rapid settling. Since the solution is acidic, step two is skipped and lime is added to reach a pH of 8.5. This readily flocks with a small addition of 0.02% anionic polymer.

(6.2) Sewage water: This wastewater has a very high organic content. Therefore, a high level of ferric chloride is added (100 ppm iron). The iron adds sufficient density to solids to facilitate rapid settling. Since the solution is alkaline, calcium chloride is added until a pH of seven is reached. Then lime is added to reach a pH of 8.5. This readily flocks with a small addition of 0.02%, anionic polymer.

7) A drill mud sample of an alkaline pH was treated with ferric sulfate solution until a pH of 7 was obtained. Lime was added until a pH of 8 was obtained. A 0.02% anionic polymer solution was added stepwise and gently mixed until clarified.

8) A drill mud sample with an alkaline pH was treated with calcium sulfate slurry until a pH of less than 7 was obtained. Lime was added until a pH of 8 was obtained. A 0.02% anionic polymer solution was added stepwise and gently mixed until clarified.

9) A drill mud sample with a neutral pH was treated with lime until a pH of 8 was obtained. A 0.02% anionic polymer solution was added stepwise and gently mixed until clarified.

10) An acidic water sample containing fecal matter was treated by adding ferric chloride to increase the iron level by 100 ppm. The pH of this mixture was acidic. Lime was added until a pH of 8 was obtained. A 0.02% anionic polymer solution was added stepwise and gently mixed until clarified.

11) A drill mud sample with an acidic pH was treated with a minimal amount ferric sulfate (10 ppm). This mixture is treated with lime until a pH of 8 was obtained. A 0.02% anionic polymer solution was added stepwise and gently mixed until clarified.

(12) Drill mud tailings. These generally contain soda ash or sodium phosphate to counter water hardness. This wastewater is generally alkaline. Ferric sulfate is added to obtain an iron concentration of 10 ppm. If the pH is still greater then seven, calcium chloride is added until a pH of less than seven is reached. Then lime is added until a pH of eight is reached. The pH may also be increased with sodium bicarbonate or potassium bicarbonate. This readily flocks with a small addition of 0.02% anionic polymer.

Handling of flock resulting from the chemical treatment of wastewater

The handling of solids, after the addition of anionic polymer is critical to successful dewatering of the solids. It is difficult to appreciate the extreme gentleness required to maintain flock integrity. Merely pumping the solids slurry or allowing the slurry to splash destroys the integrity of the flock.

I developed flock strength in the following manner.

After the addition of anionic polymer solution, no mechanical high shear devices such as pumps, centrifuges, or filter presses are used until after dewatering.

A static in-line mixer or length of pipe is used to blend the anionic polymer solution with the treated wastewater. This mixing is done by making a “T” shaped pipe apparatus designated generally 60, FIG. 4. Polymer solution is introduced into one end 62 of the “T” cross top pipe and wastewater is introduced through the opposite end 64 of the “T” cross pipe. The flow of water through end 64 is adjusted such that the ratio of the flow through end 64 is greater than one 20th the flow of wastewater being treated.

The polymer solution and wastewater are mixed along the pipe member 66 of the “T” (which may be on the order of thirty feet in length). The length of the pipe is to insure gentle mixing with adequate time. The length and diameter of the pipe is such that the resistance time in the pipe is 15 to 120 seconds. See FIG. 4.

The mixture of wastewater to dilute polymer solution is important. Some treated wastewater streams may require less than 1 ppm polymer, while others may require over 1000 ppm.

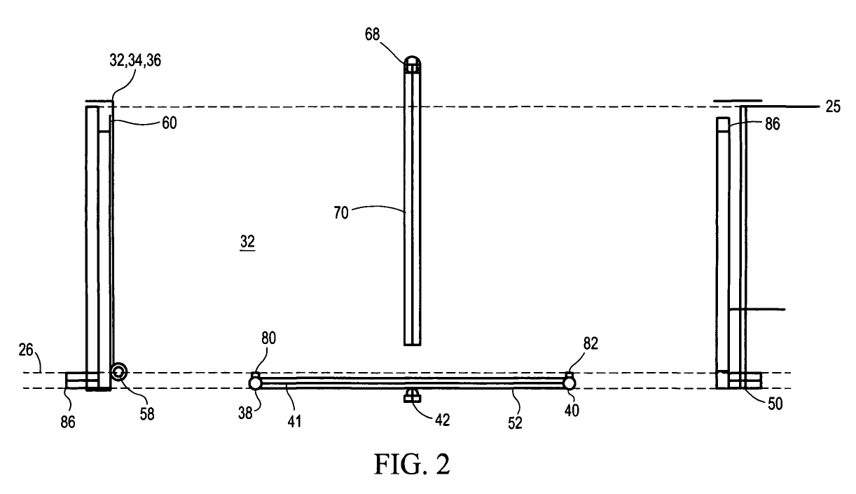

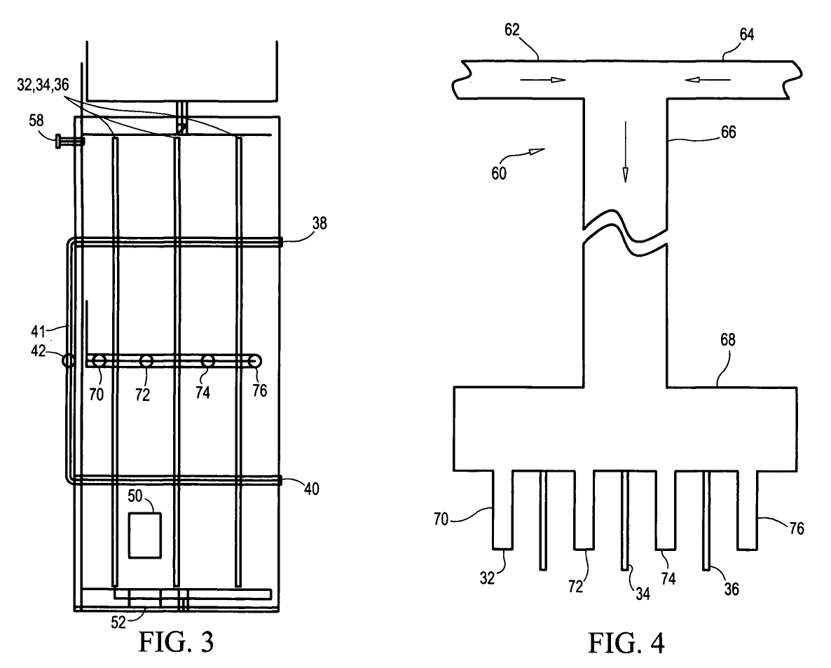

This pipe 66 terminates in a manifold pipe 68 from which extends a plurality of vertical stand pipes 70, 72, 74 and 76. The stand pipes are inserted into a clarifier tank 25 and positioned so that their bottom ends are above the floor of the tank. See FIG. 2. Between each stand pipe and its adjacent stand pipe, I provide a screened frames (32, 34 and 36) forming vertical walls. See FIG. 3.The vertical drain walls have screens with 1/16 to ½ inch holes.

This mixture is introduced underwater near the bottom at the middle of a clarifier tank. See FIG. 3.

Normally, the solids would pass right through the large mesh screen. However, since the solids slurry is introduced underwater, the solids are not pushed through the screen. As the solids accumulate between the drain walls, they gradually consolidate due to the weight of the solids above them. The process is slow enough and gentle enough that the solids are not pushed through the screen.

The level of solids is allowed to buildup in the tank. These solids act as a filter to remove the fine solids from the treated water.

The clarified water is decanted from the top and opposite sides of the clarifier tank (see FIG. 2).

Then the clarified water is passed through a polishing filter to remove any stray particles.

By the time the solids have reached the top of the settling tank, they have had adequate time to develop sheer strength. At this time the water is gradually removed from the settling tank through the vertical drain walls in a dewatering mode. The taller the drain walls are and the closer the spacing of the drain walls, the faster and more thorough is the water removal from the solids. Short wall spacing directly increases screen surface area, and reduces water travel distance, which combines to produce very low flow rates, that is, gallons per minute per square foot, and very low pressure drops; which is a function of travel distance and surface areas. The low pressure drop in turn reduces shear on the solids to facilitate consolidation. Water drains out of the solids into the space between the screens in each vertical wall. As the water level drops in the settling tank, the full weight of the solids squeezes out the water from the solids below. It is the weight of the solids themselves that facilitates the dewatering process, that is, removal of water. As the water level drops, rather than the solids being pressed through the screen, they actually pull away from the screen due to the consolidation, that is, the shrinking process; thereby lowering the level of the solids in the tank.

All of this is quite counter intuitive. One would expect the larger mesh of the screen to promote solids passing through. One would also expect the large mesh to have no effect on reducing the blinding of the screen. The large mesh screen prevents bridging, which is a precursor to blinding; and the extremely low pressure drop allows solids consolidation without shearing the solids.

There is no screen on the bottom of the settling tank, since the solids would be pushed through the screen on the bottom. There is a distinct advantage of only having vertical screens and no screen on the bottom. Solids are more likely to be pressed through a screen that is placed on the bottom. Also, a screen placed on the bottom hinders the dewatered solid removal.

Once the settling tank is fully drained over a period of hours, the solids may be disposed of in a conventional manner or dewatered further by conventional means (such as centrifuge or filter press), with a distinct advantage of having a substantially smaller volume of waste to process and without the need to produce a clear centrate or filtrate; since the liquid from the dewatering solids can be returned to the head of the water treatment process.

The solids can be removed by opening the doors located at the end or bottom of the drain tank. See 50, 52 FIG. 3.

Once the settling clarifier tank is full of solids, the slurry is moved to a second settling tank.

Water is removed through the vertical drain walls. As the water level falls in the clarifier tank, the flocked solids consolidate into larger particles. This allows the use of coarse mesh screen (large holes). The coarse mesh screen retains the solids and allows the water to drain from the solids without blinding the screen. In some cases, the water is clear enough to be released. In other cases, it is merely transferred to the beginning of the water treatment process, since this volume is small compared to the volume of water which is decanted. The weight of the solids themselves provides the force to dewater and consolidate the solids. The taller the clarifier tank and corresponding vertical drain walls, the greater the degree of dewatering. Closer vertical drain wall spacing increases the rate of dewatering. As the solids dewater they pull away from the screen. In some cases, the solids are sufficiently dewatered to pass the paint filter test and can be disposed of “as is”. No additional water drains from the solids. Since the floor of the clarifier tank is smooth, the solids are dumped out easily. The clarifier tank has a water tight door on the side or bottom of the clarifier tank which opens after the solids are dewatered to allow for easy solids removal.

These solids can be dewatered even further through conventional means such as centrifuge, screw press, or filter press. Since the volume of sludge is greatly reduced, the required processing capacity of the centrifuge or mechanical dewatering device is reduced. In addition, no additional polymer or processing chemicals are required to keep the flock stable, since the solids are more stable and the volume of centrate or filtrate is small enough to be returned to the untreated water area.

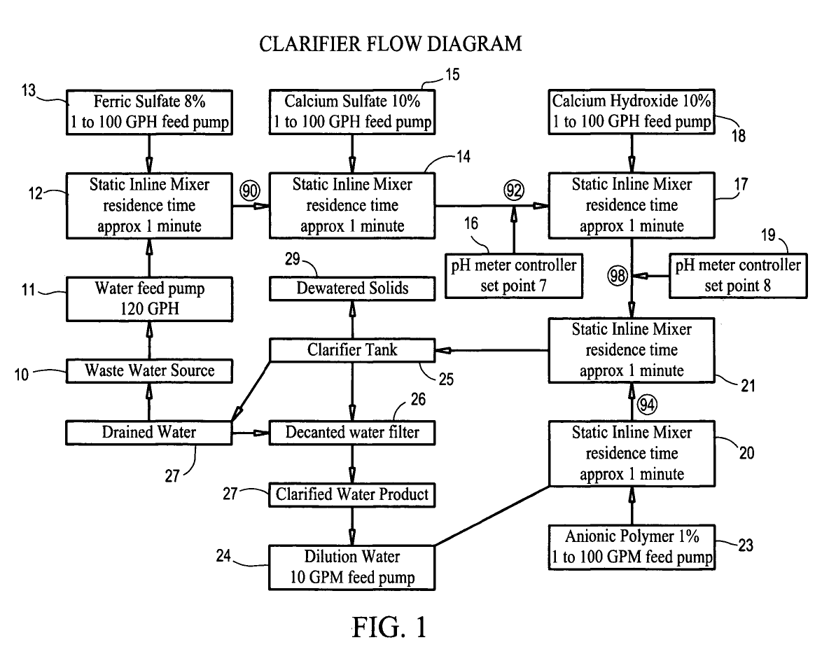

Referring to the Figures, FIG. 1 shows the flow diagram of my process.

Wastewater from source 10 is pumped at 120 gpm with feed pump 11 through static mixer 12; which mixes in 8% ferric sulfate with feed pump 13 at one to 100 gph. Wastewater flows through a flow meter. The controller adjusts the rate of the coagulant so that 20 ppm of coagulant is added to the wastewater. The residence time in the static inline mixer 12 is approximately one minute.

This mixture progresses to static mixer 14 which mixes 10% calcium sulfate through feed pump 15 at one to 100 gph; that is controlled by pH controller 16 which has a set point of pH 7. If a pH greater than 7 is detected, the controller adjusts the acidic calcium metering pump flow until the pH is about seven. If the pH is greater than pH 7, the controller outputs a signal which increases the flow of the acidic calcium metering pump. The flow is increased until a pH of about 7 is obtained. If the pH becomes too acidic, the flow of the acidic metering pump is reduced by the controller. The residence time in static inline mixer 14 is approximately one minute.

This mixture progresses to static mixer 17 that combines 10% calcium hydroxide dispensed by feed pump 18 at one to 100 gph and is controlled by pH controller 19 which has a set point of pH 8. If a pH less than 8 is detected, the controller adjusts the alkaline calcium metering pump flow until the pH is about 8. The residence time in static inline mixer 17 is approximately one minute.

This mixture progresses to static mixer 21 that combines diluted anionic polymer from static inline mixer 20.

The anionic polymer feed pump 23 delivers 1% polymer at one to 100 gph to static mixer 20 which mixes water from diluted water feed pump 24 at 10 gpm to produce dilute anionic polymer solution. The residence time in static inline mixer 21 is approximately one minute.

This mixture progresses to clarifier tank 25 where the clarified water is decanted and transferred to decanted water filter 26 to produce clarified water product 27.

When the clarifier tank 25 is in dewatering mode, it produces drained water 27 from vertical drain walls, which can be sent back to the waste water source 10 or the decanted water filter 26.

A turbidity meter means is provided, having a turbidity meter 86 located at the overflow weir 60 of the decanting tank 35 detects the clarity of the water leaving the clarifier tank. If the clarity of the water is too low, the controller adjusts the flow of the stock polymer solution feed pump. If clarity is still not obtained, the polymer feed pump flow is reduced and the amount of coagulant introduced to the wastewater is increased by the controller and the polymer dosing is adjusted by the controller again.

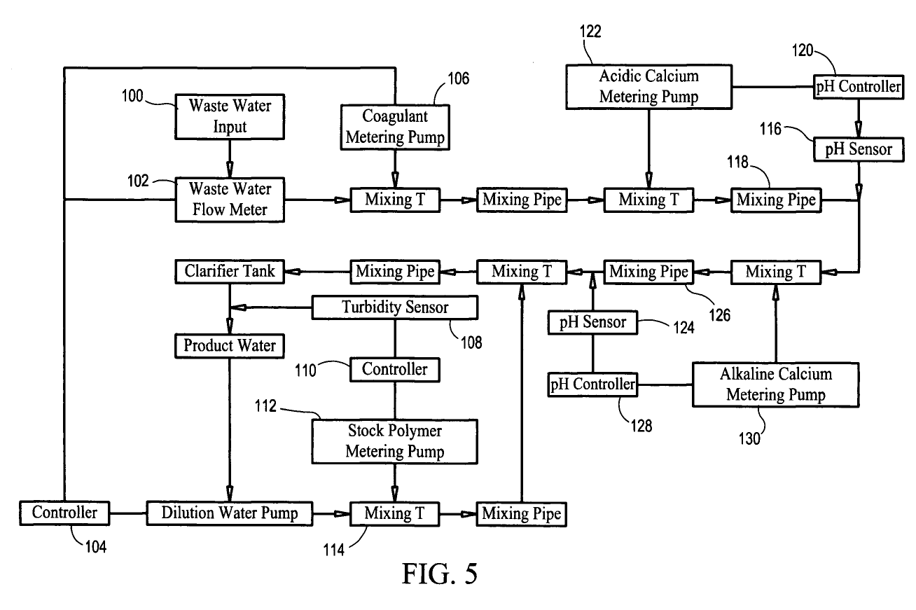

The automated apparatus means and method steps as shown in FIG. 5 compensate for variations in wastewater flow and composition.

The wastewater from a source 100 is input into the system and passes through a flow meter 102. The controller uses this flow rate value to adjust the flow of the coagulant metering pump 106 flow to maintain a constant coagulant concentration in the treated wastewater. This flow rate is also used to maintain a constant ratio of polymer dilution water flow to wastewater input flow.

The flow of the polymer dilution pump is normally adjusted such that its flow is greater than one 20th of the wastewater flow.

The turbidity meter 108 measures the clarity of the decanted water. The clarity value is used by the controller 110 to adjust the amount of stock polymer 112 feed into the polymer dilution mixer T 114 to maintain clarity.

The pH sensor 116 located at the end of acidic calcium mixing pipe 118 allows the controller 120 to adjust the feed rate of the acidic calcium metering pump 122 to maintain a pH of less than about 7.

The pH sensor 124 located at the end of alkaline calcium mixing pipe 126 allows the controller 128 to adjust the feed rate of the acidic calcium metering pump 130 to maintain a pH of about 8.

The dewatered solids 29 are discharged after draining.

### DESCRIPTION OF CLARIFIER APPARATUS

Referring to FIGS. 2 and 3, the clarifier tank 25 is shown. It has dimensions 8 feet by 8 feet by 20 feet with water tight doors 50 and 52 at the bottom and one end. See FIG. 3. The treated water is introduced by the pipe 30 underwater near the bottom and in the middle of the clarifier tank 25. The clarified water is collected by one or more overflow weirs 86 on one or both ends of the tank. Vertical drain walls 32, 34 and 36 open into drain pipes 38 and 40 located at the bottom of the clarifier tank 25. The pipes 38 and 40 are connected to a manifold discharge pipe 41. This pipe 41 has a drain valve 42 in it.

The accumulated solids are dewatered by opening the drain wall valve 42. After the solids are dewatered, they can be dumped out by opening the clarifier tank sludge doors 50 and 52 and dumping out the solids like a dump truck.

Drop in drain walls are provided. The drain wall dimensions are 2 inch by 8 feet by 19 feet and are made of a box metal frame of 2 inch box tubing (like a window frame) and are covered with 8 feet by 8 feet by 19 feet mesh screen (or perforated sheet metal with ⅛″ holes on both sides); thus providing a space there between. The window frame like drain wall has two 2″ pipes located at the bottom of the frame. See 80, 82 FIG. 2. These fit into the drain pipes 38 and 40 located at the bottom of the clarifier tank. The drain walls are about 2 feet apart. The vertical drain wall spacing is decreased for faster dewatering and increased for slower dewatering. For faster dewatering, use more drain walls. In the dewatering mode, the water flows through the screens of the vertical drain walls and out through the vertical drain wall pipes 38 and 40, while the solids are retained by the screens.

The decanted water from the clarifier tank 25 is transferred by gravity to 50 micron filter bags 26 with surface areas of about one square foot per gpm of flow.

The water in the tank 25 overflows weirs and is sent to the clarified water filter 26. A dam (similar to the flap valve in a swimming pool surface filter system that catches leaves) positioned before the weir can be used to prevent floating particles from entering the weir; such as particles of fat which have a density less than 1 (the density of water).

The drain wall valve 42 is opened when clarifier tank is in drain mode.

When the system starts up it is desirable to have some water in the clarifier tank 25. Thus it is desirable to have an input water valve 58 to allow a foot or so of water to enter the clarifier tank.

Water flows from the static in-line mixer 21 and begins to fill the clarifier tank 25 and build up an increasing level of solids.

Once the water gets near the top of the clarifier tank 25 it overflows the weir 60 and proceeds to go to the filter bags 26.

Once the solids get to the top of the clarifier tank 25, it's necessary to open the drain wall valve 42. It can then either flow to the filter bags 26 or to the wastewater system source 10.

At that point, the process water will go to another clarifier tank, while the water is draining out of the bottom of the first clarifier box.

Then the solids from the first clarifier box can be removed.

When the second box is full, repeat these steps and switch back to the first box.

From what I have described herein I have invented a universal wastewater treatment formula comprising:

1) Adding a coagulant, such as ferric or aluminum sulfate at 10 ppm for low organic matter; or for high organic matter increase the coagulant level.

2) If pH is greater than 7, add calcium sulfate (or calcium chloride) until pH 7 is reached.

3) Add calcium hydroxide until a pH of 8 to 9 is obtained.

4) Add anionic polymer until the water clarifies. If water does not clarify, increase the coagulant used in step 1.

Some treatment examples are:

1) One ml ferric sulfate (1,000 ppm iron) added to 100 ml water to produce a 10 ppm iron concentration.

1% calcium hydroxide added until a pH of 8 is produced.

Two ml of 0.02% anionic polymer added to produce a concentration of 4 ppm polymer.

Gently stir until water clarifies.

2) One ml ferric sulfate (5,000 ppm iron) added to 100 ml water to produce a 50 ppm iron concentration.

1% calcium hydroxide added until a pH of 8 is produced.

Two ml of 0.02% anionic polymer added to produce a concentration of 4 ppm polymer.

3) One ml aluminum sulfate (2,000 ppm aluminum) added to 100 ml water to produce a 20 ppm aluminum concentration.

1% calcium hydroxide added until a pH of 8 is produced.

Two ml of 0.02% anionic polymer added to produce a concentration of 4 ppm polymer.

4) One ml aluminum sulfate (2,000 ppm aluminum) added to 100 ml of 1% fumed aluminum oxide slurry.

1% calcium hydroxide added until a pH of 8 is produced.

0.02% anionic polymer solution added and gently mixed until clear.

5) 1% alkaline clay treated with one ml 1% ferric sulfate. 1% calcium sulfate slurry added until a pH of 7 is obtained. 1% lime solution added until pH of 8 is obtained. 0.02% anionic polymer solution added and gently mixed until clear.

6) 1% slurry of fecal matter treated 10 ml of ferric sulfate added. 1% lime slurry added until pH of 8 is obtained. 0.02% solution of anionic polymer added and mixed until water clarifies.

I have replaced the use of organic polymers with inorganic salts.

I have consolidated the solids; thereby reducing them in the first instance by 80%. There remains only 20% which are soluble.

The taller the tank, the better because of the weight of the solids actually pulls the flock away from the walls and the screens.

The residence time is about two minutes from the time the wastewater is first introduced to the time that it is introduced into the clarifier tank.

I introduce the flock underneath the water and allow it to settle; thereby consolidating that the flock and developing its strength. It becomes a filtering mechanism. Use of a fine screen in the prior art that didn't work because it blinded. A quarter inch to half inch screen doesn't blind.

My invention works, in part, because of the extreme gentleness I use as opposed to the shearing effects of existing apparatuses.

My universal clarifier works without chemical analysis.

In the first step, a sample is taken in a jar to test for insufficient solids. Iron is added; such as by introducing 10 ppm of ferric chloride up to 100 ppm.; to show that solids are dropping out. This takes a matter of seconds.

A pH meter/controller automatically adjusts for a pH which is acidic, that is, less than seven. Note that in wastewater streams, the character changes. This step takes a matter of seconds.

At first blush, acidifying water in order to make it alkaline again seems pointless. Yet one cannot destroy the soap properties of sodium carbonate or sodium phosphate without adjusting the pH to about seven. At the same time, one cannot minimize the amount of calcium in solution without adjusting the pH to about eight. If too much calcium is in solution, excessive amounts of anionic polymer are required.

I then use cross-linking alkaline calcium or magnesium salts chemical materials to convert the water back into an alkaline condition, such as by the use of inexpensive calcium or magnesium salts; thereby raising the pH to 8.5. This process takes less than 30 seconds.

The anionic polymer, in turn, cross-links with the polyvalent cations such as calcium and iron ions on the surface of the treated solids.

Therefore, I am able to accommodate huge flow rates.

I have provided an apparatus for clarifying wastewater, comprising: a first static mixer 12; input pump means 11 for pumping the wastewater from a source 10 through said first static mixer 12; a first feed pump means 13 for pumping a coagulant into said first static mixer 12; a second static mixer 14; a first conduit means 90 for transferring the resulting coagulant wastewater in said first static mixer 12 to said second static mixer 14; a second pump means 15 for pumping chemicals into said second static mixer 14 to change the pH of the wastewater therein to about 7; a third static mixer 17; a second conduit means 92 for transferring the wastewater from the second static mixer 14 into the third static mixer 17; a pH meter/controller 16 downstream of the second static mixer 14 to control the second pump means 15; a third pump means 18 for pumping chemicals into said third static mixer 17 to change the pH of the wastewater therein to acidic; a pH meter/controller 19 downstream of the third static mixer 17 to control the third pump means 18; a fourth static mixer 20; a fourth pump means 23 for pumping polymer into said fourth static mixer 20; a fifth pump means 24 for pumping water into said fourth static mixer 20 to make a diluted anionic polymer mixture; a fifth static mixer 21; a third conduit means 94 for transferring the diluted anionic polymer mixture from said fourth static mixer 20 into said fifth static mixer 21; a fourth conduit means 98 for transferring the acidic wastewater from static mixer 17 into said fifth static mixer 21 to form a flock containing wastewater; a clarifier tank 25 having a bottom and side walls; an apparatus FIGS. 2, 3 and 4 to convey the flock containing wastewater into said tank, comprising, in part, a plurality of vertical stand pipes 70, 72, 74 and 76 positioned in said clarifier tank at the middle of said clarifier tank so that their bottom ends are above the bottom of said tank; screened frames forming vertical walls 32, 34 and 36 positioned in between each stand pipe and its adjacent stand pipe; at least one door 50 in said tank, decanting means 60 for decanting wastewater from said tank; drain means 80, 82, 38, 40, 41 and 42. for draining said tank of water produced by dewatering said flock.

I claim:

1. A method of clarifying wastewater comprising the steps of:
a. adding a coagulant to the wastewater to produce treated wastewater with solids;
b. then adjusting the pH of the treated wastewater to about 7 to produce treated wastewater with a pH of about 7;
c. then adjusting the pH of the treated wastewater with a pH of about 7, to about 8 to produce treated wastewater with a pH of about 8;
d. then adding an anionic polymer to the treated wastewater with a pH of about 8 to produce a wastewater with flock;
e. then dewatering the flock through gentle means for dewatering substantially without subjecting the flock to shear.

2. In the method of claim 1, adding a calcium salt in step b.

3. In the method of claim 2, adding an acidic calcium salt in step b.

4. In the method of claim 3, adding a low water soluble calcium salt in step b.

5. In the method of claim 1, adding calcium hydroxide in step c.

6. In the method of claim 1, adding a high molecular weight anionic polymer in step d.

7. In the method of claim 6, adding a high molecular weight in the range of approximately 1% to 40% charge anionic polymer in step d.

8. In the method of claim 6, adding an anionic polymer in a concentration of less than 0.1% in step d.

9. In the method of claim 6, adding an anionic polymer in a concentration of approximately 10 parts water to one part wastewater in step d.

10. In the method of claim 1, providing a settling tank; introducing water into the tank; then introducing the treated wastewater with flock into the settling tank below the water level of the water in the settling tank.

11. The method of claim 1 having the additional step of decanting the wastewater with flock prior to dewatering the flock.

12. The method of claim 1 wherein providing a settling tank; providing a plurality of dual screen walls in the settling tank; introducing water into the settling tank; and then introducing the treated wastewater with flock into the settling tank below the water level of the water in the settling tank.

13. The method of claim 1 wherein the introduction of polymer into the wastewater in step 1d is done continuously on an as needed basis.

14. The method of claim 1 wherein the coagulant is an iron salt.

15. The method of claim 3 wherein adjusting the pH with a calcium salt, is selected from the group consisting of: calcium chloride, calcium sulfate, and calcium nitrate.

16. The method of claim 3 wherein adjusting the pH is done with a coagulant selected from the group consisting of: aluminum sulfate, ferric sulfate, aluminum chloride, ferric chloride, aluminum nitrate, and ferric nitrate.

17. The method of claim 1 wherein adjusting the pH to about 8 is done by adding chemicals selected from the group consisting of calcium hydroxide, magnesium hydroxide, alkaline calcium salt, and magnesium salts.

18. A method of clarifying wastewater comprising the steps of:
a. adding a coagulant to the wastewater to produce treated wastewater with solids;
b. testing the treated wastewater to see if it is acidic, and then, if the treated wastewater is acidic, adjusting the pH of the treated wastewater to about 8 to produce treated wastewater with a pH of about 8;
c. then adding an anionic polymer to the treated wastewater with a pH of about 8 to produce a wastewater with flock; and
e. then dewatering the flock through gentle means for dewatering substantially without subjecting the flock to shear.

19. An apparatus for clarifying wastewater, comprising: a first static mixer; input pump means for pumping the wastewater from a source through said first static mixer; a first feed pump means for pumping a coagulant into said first static mixer; a second static mixer; a first conduit means for transferring the resulting coagulant wastewater in said first static mixer to said second static mixer; a second pump means for pumping chemicals into said second static mixer to change the pH of the wastewater therein to about 7; a third static mixer; a second conduit means for transferring the wastewater from the second static mixer into the third static mixer; a pH meter/controller downstream of the second static mixer to control the second pump means; a third pump means for pumping chemicals into said third static mixer to change the pH of the wastewater therein to acidic; a pH meter/controller downstream of the third static mixer to control the third pump means; a fourth static mixer; a fourth pump means for pumping polymer into said fourth static mixer; a fifth pump means for pumping water into said fourth static mixer to make a diluted anionic polymer mixture; a fifth static mixer; a third conduit means for transferring the diluted anionic polymer mixture from said fourth static mixer into said fifth static mixer; a fourth conduit means for transferring the acidic wastewater from static mixer into said fifth static mixer to form a flock containing wastewater; a clarifier tank having a bottom and side walls; an apparatus to convey the flock containing wastewater into said tank, comprising, a plurality of vertical stand pipes positioned in said clarifier tank at the middle of said clarifier tank so that their bottom ends are above the bottom of said tank; screened frames forming vertical walls positioned in between each stand pipe and its adjacent stand pipe; at least one door in said tank, decanting means for decanting wastewater from said tank; drain means for draining said tank of water produced by dewatering said flock.

20. The apparatus of claim 19 wherein a turbidity meter/controller means is located at the decanting means to detect the clarity of the water leaving the clarifier tank and, if the clarity of the water is too low, the turbidity meter/controller means adjusts the flow of the stock polymer solution through said fourth feed pump, and, if clarity is still not obtained, the flow of polymer solution fourth feed pump flow is reduced and the amount of coagulant introduced to the wastewater is increased by the turbidity meter controller means and the polymer flow is adjusted by the turbidity meter/controller means again.

21. The apparatus of claim 19 having an automated apparatus means to compensate for variations in wastewater flow and composition comprising:
a flow meter; a controller which uses the flow rate value through the flow meter to adjust the flow of a coagulant metering pump to maintain a constant coagulant concentration in the treated wastewater and to maintain a constant ratio of polymer dilution water flow to wastewater input flow;
a turbidity meter for measuring the clarity of the decanted water; a controller which uses the clarity value to adjust the amount of stock polymer feed into the polymer dilution mixer to maintain clarity;
a pH sensor located at the end of an acidic calcium mixing pipe for allowing a controller to adjust the feed rate of the acidic calcium metering pump to maintain a pH of less than about 7;
a pH sensor located at the end of an alkaline calcium mixing pipe to allow a controller to adjust the feed rate of the acidic calcium metering pump to maintain a pH of about 8.
